(19) United States
(12) Patent Application Publication
(10) Pub. No.: US 2004/0044743 A1
(43) Pub. Date: Mar. 4, 2004

(54) Method and apparatus for hyperlinked graphics tool

(76) Inventors: Craig Monell, Encinitas, CA (US); Benjamin Kraft, San Diego, CA (US); Diane Haines, Redondo Beach, CA (US); Meng Fu Shih, San Diego, CA (US)

Correspondence Address: James Y Sze, Pillsbury Winthrop, Suite 200, 11682 El Camino Real, San Diego, CA, 92130, US

(21) Appl. No.: 10/257,713

(22) PCT Filed: May 11, 2001
(86) PCT No.: PCT/US01/15474

(51) Int. Cl. G06F 15/16; G06F 17/30; G06F 7/00

(52) U.S. Cl. 709/217

(57) ABSTRACT

A method and apparatus that allows information to automatically be obtained from a remote database through a user constructed interactive graphic user interface. A hyperlink is associated with an icon or image file. The hyperlink connects the icon to data stored within a database. The data represents information related to the picture represented on the icon. The icons are collected and distributed electronically for incorporation into pictures. The resulting picture allows one to access the database, which is updated with information related to the pictures represented on the icons.

### RELATED APPLICATIONS

This application claims the benefit of co-pending U.S. Provisional Application Serial No. 60/203,949 filed May 12, 2000.

### BACKGROUND

1. Field of the Invention

Aspects of the present invention relate in general to a method and apparatus that associates database information to hyper-linked objects.

2. Description of the Related Art

Conventional pictures and icons are used to depict complex ideas and processes. For example, scientists often use pictures to illustrate complex molecular interactions. In recent years, the use of “clip art” libraries have simplified the construction of illustrations by allowing illustrators to copy and paste an image into a document or drawing.

Often, as scientific understanding of various molecules and molecular interactions improve, the knowledge encapsulated by older drawings becomes dated. However, the static nature of clip art pictures prevents information represented by a picture from being updated.

### BRIEF DESCRIPTION OF THE DRAWINGS

FIG. 1 illustrates an embodiment of a system that allows users to construct diagrams that provides access to information specific to objects within the diagrams.

FIG. 2 is a block diagram of an apparatus that allows users to construct diagrams that provides access to information specific to objects within the diagrams.

FIG. 3 depicts an embodiment of a web browser interface practicing a method of providing access to information specific to objects within diagrams.

FIG. 4 is a flowchart a method embodiment that makes objects available to users; the objects allow construction of diagrams that provide access to information specific to objects within the diagrams

FIG. 5 is a flowchart of a method that allows users to construct diagrams that provides access to information specific to objects within the diagrams.

FIG. 6 is a block diagram of an embodiment of an apparatus that allows users to construct diagrams that provides access to information specific to objects within the diagrams.

### DETAILED DESCRIPTION

What is needed is an integrated process that allows information to automatically be obtained from a remote database through a user constructed interactive graphic user interface. Embodiments of the present include a method and apparatus that associates database information to hyperlinked objects or images. Users of the method or apparatus embodiment may retrieve information associated with the object by accessing the hyperlink.

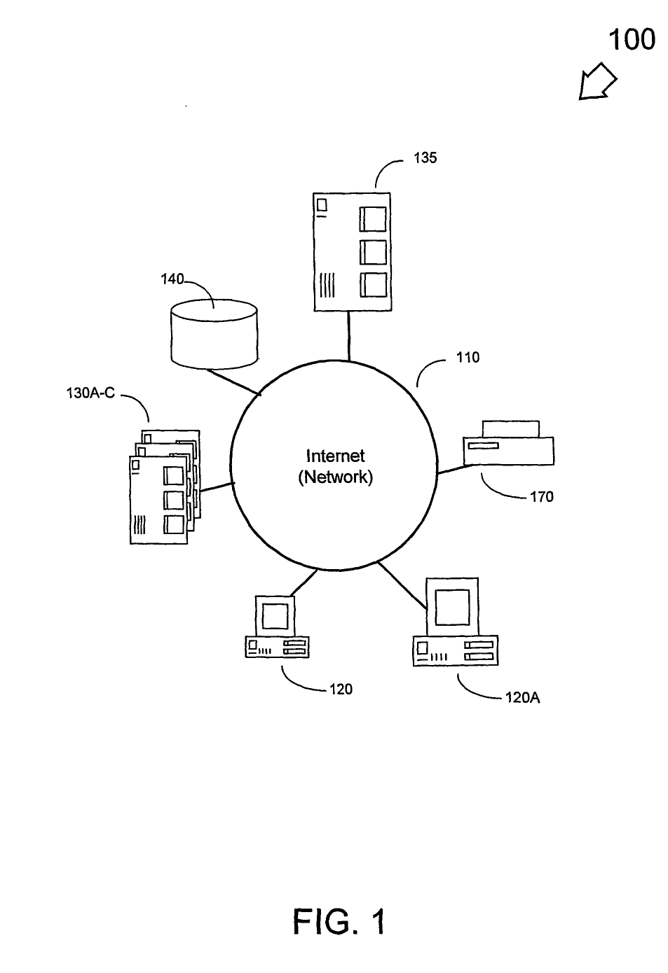

FIG. 1 is a simplified functional block diagram depicting system 100, constructed and operative in accordance with an embodiment of the present invention. System 100 is configured to allow users access to objects embedded with hyperlinks, to construct diagrams with the objects, to store information related to the hyperlinks, and to allow users to access information related to the hyperlinks. Objects include, but are not limited to, any graphical representation of information, such as pictures, diagrams, or graphical representation of pictures and text, that may be embedded with a hyperlink. A typical example is an icon, generated by an electronic drawing program (such as Microsoft Power Point™, Adobe Illustrator™, or Macromedia Freehand™) that is associated with a hyperlink embedded in within the icon.

In system 100, computer 120 and a library server 135 are connected to a communications network 110. The network 110 may also include other networkable devices known in the art, such as other computers 120, servers 130, printers 170 and storage media 140. It is well understood in the art, that any number or variety of computer networkable devices or components may be coupled to the network 110 without inventive faculty. Examples of other devices include, but are not limited to, servers, computers, workstations, terminals, input devices, output devices, printers, plotters, routers, bridges, cameras, sensors, or any other such device known in the art. Computer 120 may be of any kind known in the art that is able to communicate on the network 110. Servers 130A-C may be any servers known in the art, including web, database, print, or application servers. More importantly, in some embodiments, servers 130A-C may generate, originate, or participate in distributing objects in conjunction with the library server 135.

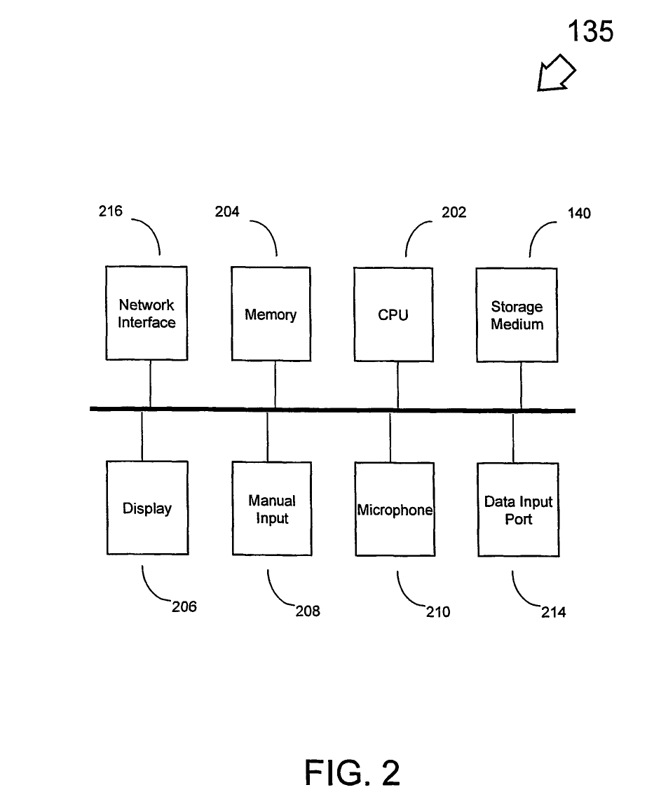

Network 110 may be any communication network known in the art, including the Internet, a local-area-network (LAN), a wide-area-network (WAN), or any system that links a computer to a library server 135. Further, network 110 may be of configured in accordance with any topology known in the art, including star, ring, bus, or any combination thereof Embodiments will now be disclosed with reference to a functional block diagram of an exemplary library server 135 of FIG. 2. Library server 135 runs a multi-tasking operating system and includes at least one central processing unit (CPU) 202. CPU 202 may be any microprocessor or micro-controller as is known in the art. The software for programming the CPU 202 may be found at a computer-readable storage medium 140 or, alternatively, from another location across network 110. CPU 202 is connected to computer memory 204. Library server 135 is controlled by an operating system (OS) that is executed within S computer memory 204.

CPU 202 communicates with a plurality of peripheral equipment, including network interface 216. Additional peripheral equipment may include a display 206, manual input device 208, storage medium 140, microphone 210, and data input port 214. Display 206 may be a visual display such as a cathode ray tube (CRT) monitor, a liquid crystal display (LCD) screen, touch-sensitive screen, or other monitors as are known in the art for visually displaying images and text to a user. Manual input device 208 may be a conventional keyboard, keypad, mouse, trackball, or other input device as is known in the art for the manual input of data. Storage medium 140 may be a conventional read/write memory such as a magnetic disk drive, floppy disk drive, compact-disk read-only-memory (CD-ROM) drive, digital video disk read-only-memory (DVD-ROM), digital video disk read-access-memory (DVD-RAM), transistor-based memory or other computer-readable memory device as is known in the art for storing and retrieving data. Significantly, storage medium 140 may be remotely located from CPU 202, and be connected to CPU 202 via a network 110 such as a local area network (LAN), a wide area network (WAN), or the Internet.

Microphone 210 may be any suitable microphone as is known in the art for providing audio signals to CPU 202. In addition, a speaker (not shown) may be attached for reproducing audio signals from CPU 202. It is understood that microphone 210 and speaker may include appropriate digital-to-analog and analog-to-digital conversion circuitry as appropriate.

Data input port 214 may be any data port as is known in the art for interfacing with an external accessory using a data protocol such as RS-232, Universal Serial Bus (USB), or Institute of Electrical and Electronics Engineers (IEEE) Standard No. 1394 (‘Firewire’).

Network interface 216 may be any interface as known in the art for communicating or transferring files across a computer network, examples of such networks include Transmission Control Protocol/Internet Protocol (TCP/IP), Ethernet, Fiber Distributed Data Interface (FDDI), token bus, or token ring networks. In addition, on some systems, network interface 216 may consist of a modem connected to the data input port 214.

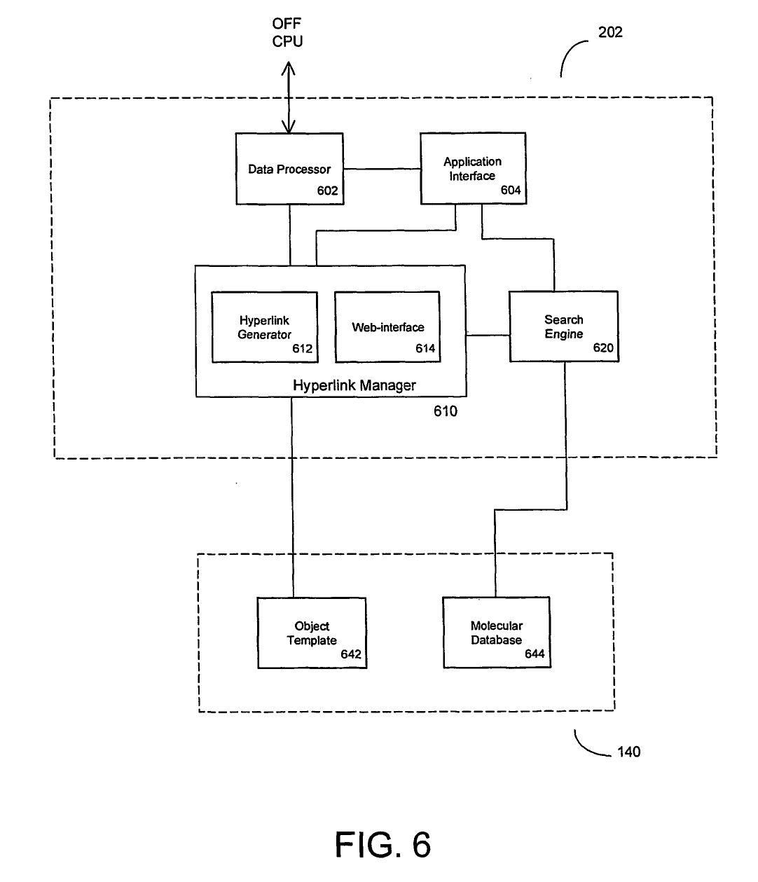

FIG. 6 is an expanded functional block diagram of CPU 202 and storage medium 140. It is well understood by those in the art, that the functional elements of FIG. 6 may be implemented in hardware, firmware, or as software instructions and data encoded on a computer-readable storage medium 140. As shown in FIG. 6, central processing unit 202 is functionally comprised of a data processor 602, an application interface 604, a hyperlink manager 610, and a search engine 620. Data processor 602 interfaces with display 206, manual input device 208, storage medium 140, microphone 210, data input port 214, and network interface 216. The data processor 602 enables CPU 202 to locate data on, read data from, and write data to, these components.

Application interface 604 enables CPU 202 to take some action with respect to a separate software application or entity. For example, application interface 604 may take the form of a windowing user interface, as is commonly known in the art.

Hyperlink manager 610 handles the association of hyperlinks to objects and interfaces with hyperlink inquiries via World-Wide-Web browsers, while search engine 620 responds to queries to the molecular database 644.

Hyperlink manager 610 may be further comprised of a hyperlink generator 612 and a web interface 614.

Hyperlink generator 612 is the structure that associates hyperlinks to imaged-mapped electronic objects. The hyperlink associated with the object relate to a database 644 that stores information related to the image depicted by the object. For example, for an object with a molecule image, the hyperlink may be a query to a molecular database 644 that returns information about molecular interactions, protein and DNA/RNA sequences, articles related to the molecule, a discussion board related to the molecule, scientific publications, and commercial reagents related to the molecule. Furthermore, hyperlink generator 612 may also verify that the associated hyperlinks are valid and that the resulting object is stored in an object template 642. Such an object template 642 may be stored on storage media 140, and may be comprise any graphical template or database known in the art. In some embodiments object template 642 is a relational drawing database.

Web interface 614 is that structure or program that allows central processing unit 202 and network interface 216 to process hyperlink and other data requests from the World-Wide-Web. Web interface 614 may be any world-wide-web server as is known in the art.

Search engine 620 may be any interface, as is known in the art, that responds to a hyperlink database query. For example, search engine 620 may be a simple query language (SQL) based interface to a database 644.

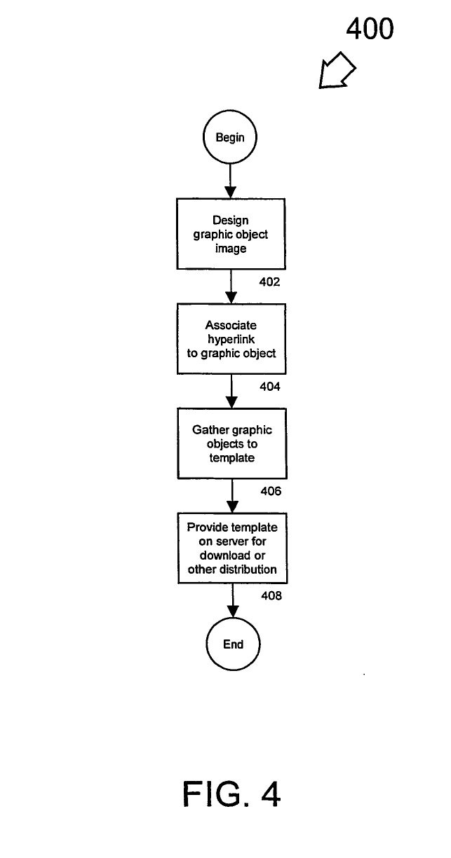

FIG. 4 is a flow diagram depicting process 400, constructive and operative in accordance with an embodiment of the present invention. The embodiment discloses the creation and distribution of graphical objects. For ease of understanding, the objects are assumed to be icons that depict molecular and cellular interactions. It is well understood in the art that the concepts herein equally apply to any form of graphical object, as defined above.

As shown in block 402, the graphic object is designed. The graphic object design, of course, depends upon the image to be depicted by the icon. In embodiments that allow users to design images depicting molecular and cellular interactions, the graphic object may be an image of a molecule. In some embodiments, the icon image may be designed by an artist using an electronic drawing program, such as Microsoft Power Point™, Adobe Illustrator™, or Macromedia Freehand™.

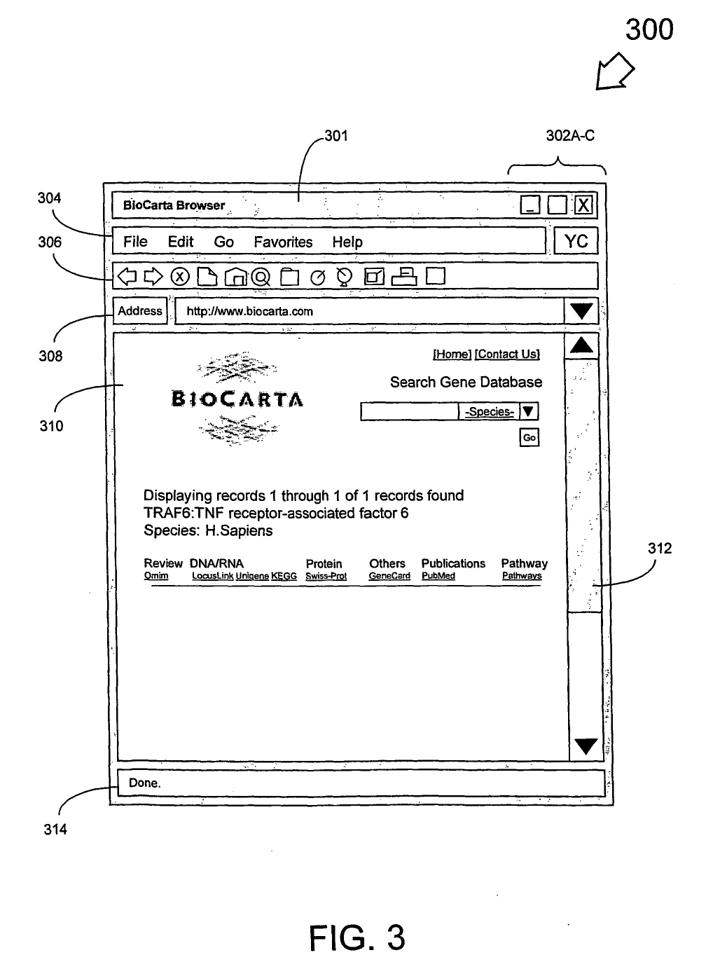

In block 404, a hyperlink is associated with the graphic object via the hyperlink generator 612. This may be accomplished by using a feature of the electronic drawing program, such as any of the programs discussed above. The hyperlink directs a user to library server 135, wherein library server 135 performs a database query or other information retrieval based upon the graphic object being depicted. For example, in a situation where a molecule is being depicted, the hyperlink may be directed to database 644. Alternatively, in some embodiments, the hyperlink may direct a user to a particular World-Wide-Web page that returns the result of search engine 620. Such a page is depicted in FIG. 3.

FIG. 3 depicts an embodiment of a web browser window 300 practicing a method of providing access to information specific to objects within diagrams. Web browser window 300 comprises title bar 301, window control buttons 302A-C, menu bar 304, button bar 306, address bar 308, main frame 310, main frame scroll bar 312, and status bar 314. As shown in main frame 310, the hyperlink may direct a user to a particular World-Wide-Web page that returns the result of search engine 620. The resulting information about molecular interactions include: protein and DNA/RNA sequences, articles related to the molecule, a discussion board related to the molecule, scientific publications, and commercial reagents related to the molecule.

Returning to FIG. 4, in block 406, the resulting graphic objects are gathered by the hyperlink generator 612 for collection into an object template 642, or drawing database. In a molecular and cellular interaction embodiment, object template 642 contains one icon for each molecule. To represent the approximately 100,000 human genes, object template 642 will contain 100,000 icons to represent the gene products. Additionally, object template 642 contains additional icons to represent activities and cellular interactions. Examples of additional icons are arrow icons that are positioned between molecules to denote specific activities. The resulting object template 642, object database, or elements from the database is then made available for distribution, block 408. The distribution may be by any electronic or mechanical method known in the art, including making the object template available for download via file transfer protocol (FTP), via the World-Wide-Web, or via distribution of storage media 140 (e.g., floppy disk, CD-ROM, DVD-ROM, DVD-RAM, mini-disc, or any other computer readable storage format).

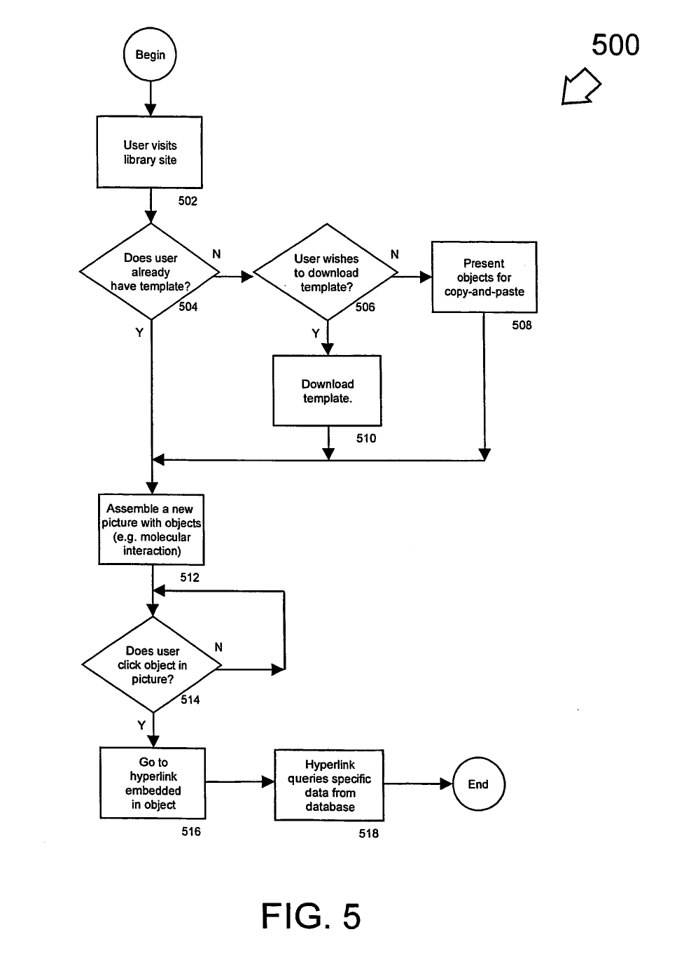

FIG. 5 is a flow diagram depicting process 500. Process 500 describes an embodiment of a method that allows users to construct diagrams that provides access to information specific to objects within the diagrams, from the point of a system user. A system user, using web-browser window 300 on computer 120A, visits library site 135, block 502.

At block 504, a determination is made whether user already has the object template 642. If so, flow continues at block 512. Otherwise, at decision block 506, the user is offered the opportunity to download the object template, at block 510, or the objects may be presented for copy-and-paste at block 508.

At block 512, the user may assemble a new picture using the objects from object template 642. In some embodiments, a user uses the object template 642 to copy and paste (or “drag and drop”) the icons/objects into a new picture representing how molecules interact. Once the picture is acceptable, the user can use the function of a commercial drawing program to save the file in hypertext markup language (“html”). This results in a graphics file and an affiliated html source file. The graphics file may be of kind known in the art, such as a Joint Photographic Experts Group (JPEG), Graphics Interchange Format (GIF), Portable Network Graphics (PNG), or Run Length Encoded (RLE) formats.

Using a web-browser-window 300, the user can then view the resulting picture.

If the picture is viewed while computer 120A is connected to network 110, then clicking on any object in the picture will activate the hyperlink, block 516. In block 518, the hyperlink calls upon web-interface 614, which routes the hyperlink to search engine 620. As mentioned above, in some embodiments, search engine 620 may be a web-accessible file in a directory at library server 135. Such a directory contains a single file for each hyperlinked icon in the object template (i.e. one file for each of the 100,000 human genes). The accessed file queries a database 644 to return to the user information specific to the molecule depicted in the original icon that was clicked by the user.

Since all links become redirected, it is possible to update database 644 or links within the database. Consequently, pictures previously created on the library server 135 and those that exist on remote external servers 130A-C, will still access the appropriate updated information.

The previous description of the embodiments is provided to enable any person skilled in the art to practice the method. The various modifications to these embodiments will be readily apparent to those skilled in the art, and the generic principles defined herein may be applied to other embodiments without the use of inventive faculty. Thus, the present invention is not intended to be limited to the embodiments shown herein, but is to be accorded the widest scope consistent with the principles and novel features disclosed herein.

What is claimed is:

1. A method comprising:
embedding a hyperlink to a graphic object, the graphic object containing an image, the hyperlink associating the graphic object with a hypertext database with information related to the image;
gathering the graphic objects;
distributing the gathered graphic objects.

2. The method of claim 1 wherein the gathered graphic objects are distributed via a network.

3. The method of claim 1 wherein the gathered graphic objects are distributed via storage media.

4. The method of claim 1 wherein the gathered graphic objects are distributed via a network or storage media.

5. The method of claim 4 wherein the graphic objects are gathered into a template.

6. The method of claim 4 wherein the graphic objects are gathered into a drawing database.

7. The method of claim 4 wherein the graphic objects are gathered into a template or a drawing database.

8. The method of claim 7 wherein the image of the graphic objects represents molecules, molecular interactions, or cellular interactions.

9. The method of claim 8 wherein the hypertext database comprises information about the image in the form of: protein sequences, DNA sequences, RNA sequences, scientific publications, discussion boards, or commercial reagents related to the molecules.

10. A computer-readable medium encoded with data and instructions, such that when read by a computer, the computer is caused to:
embed a hyperlink to a graphic object, the graphic object containing an image, the hyperlink associating the graphic object with a database with information related to the image;
gather the graphic objects;
distribute the gathered graphic objects.

11. The computer-readable medium of claim 10 wherein the gathered graphic objects are distributed via a network.

12. The computer-readable medium of claim 10 wherein the gathered graphic objects are distributed via storage media.

13. The computer-readable medium of claim 10 wherein the gathered graphic objects are distributed via a network or storage media.

14. The computer-readable medium of claim 13 wherein the graphic objects are gathered into a template.

15. The computer-readable medium of claim 13 wherein the graphic objects are gathered into a drawing database.

16. The computer-readable medium of claim 13 wherein the graphic objects are gathered into a template or a drawing database.

17. The computer-readable medium of claim 16 wherein the image of the graphic objects represents molecules, molecular interactions, or cellular interactions.

18. The computer-readable medium of claim 17 wherein the hypertext database comprises information about the image in the form of: protein sequences, DNA sequences, RNA sequences, scientific publications, discussion boards, or commercial reagents related to the molecules.

19. An apparatus comprising:
a network interface;
a hypertext database, coupled to the network interface; and
a web interface, coupled to the network interface and the hypertext database, to receive a request from a hyperlink embedded in a graphic object, the graphic object to contain an image, the hyperlink to associate the graphic object with a hypertext database with information related to the image.

20. The apparatus of claim 19 wherein the image of the graphic object represents molecules, molecular interactions, or cellular interactions.

21. The apparatus of claim 20 wherein the hypertext database comprises information about the image in the form of: protein sequences, DNA sequences, RNA sequences, scientific publications, discussion boards, or commercial reagents related to the molecules.

22. An apparatus comprising:
a hyperlink generator to embed a hyperlink into a graphic object, the graphic object contains an image, the hyperlink to associate the graphic object with a hypertext database with information related to the image, to gather the graphic objects; and
an object template, coupled to the hyperlink generator, to receive the gathered objects.

23. The apparatus of claim 22 wherein the gathered graphic objects are distributed via a network.

24. The apparatus of claim 22 wherein the gathered graphic objects are distributed via storage media.

25. The apparatus of claim 22 wherein the gathered graphic objects are distributed via a network or storage media.

26. The apparatus of claim 25 wherein the image of the graphic objects represents molecules, molecular interactions, or cellular interactions.

27. The apparatus of claim 26 further comprising:
a search engine coupled to the hyperlink generator;
a hyperlink database, coupled to the search engine, the hyperlink database to comprise information about the image in the form of: protein sequences, DNA sequences, RNA sequences, scientific publications, discussion boards, or commercial reagents related to the molecules, the search engine to search the hyperlink database.
